(19) United States
(12) Patent Application Publication
(10) Pub. No.: US 2004/0263097 A1
(43) Pub. Date: Dec. 30, 2004

(54) Light output controlling apparatus and method

(76) Inventor: Jong-min Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/858,571

(22) Filed: Jun. 2, 2004

(30) Foreign Application Priority Data
Jun. 4, 2003 (KR) 2003-35899

(51) Int. Cl. H05B 39/04

(52) U.S. Cl. 315/291; 315/224; 315/307

(57) ABSTRACT

A light output controlling apparatus and method is provided. The light output controlling apparatus includes a voltage comparing unit for comparing a reference voltage to a feedback voltage and a light source for radiating a light. The apparatus also includes an input voltage supplying unit, which is connected to the light source and supplies the feedback voltage maintained at a constant offset with respect to the variable input voltage to the voltage comparing unit. Therefore, the feedback voltage input into the voltage comparing unit can be maintained constantly, thus preventing a strength of the light from being changed and an output image from degrading.

### PRIORITY

This application claims the benefit under 35 U.S.C. §119(a) of Korean Patent Application No. 2003-35899, filed on Jun. 4, 2003, in the Korean Intellectual Property Office, the entire disclosure of which is incorporated herein by reference.

### BACKGROUND OF THE INVENTION

1. Field of the Invention

The present invention relates to a light output controlling apparatus and method included in an electric device such as a laser printer, a multi function product (MFP), or a laser facsimile. More particularly, the present invention relates to a light output controlling apparatus and method for preventing degradation of an output image by preventing the strength of a light from being changed.

2. Description of the Related Art

FIG. 1 is a circuit diagram of a conventional light output controlling apparatus. As shown in FIG. 1, the conventional light output controlling apparatus includes a voltage comparing unit 10, a light source 20, and an input voltage supplying unit 30.

The voltage comparing unit 10 compares a reference voltage to a feedback voltage Vf, and outputs the compared result. The voltage comparing unit 10 generally includes a NAND gate.

The light source 20 receives electric current according to the compared result output from the voltage comparing unit 10, radiates light, and detects a strength of the radiated light. The light source 20 includes a laser diode (LD) to radiate the light according to the input current. Also, the light source 20 includes a photo diode (PD) to detect the strength of the radiated light.

The input voltage supplying unit 30 receives the current output from the light source 20, supplies a voltage, which is made by subtracting a variable voltage applied to a variable resistor Rv from input voltage Vcc supplied from a voltage supplying source (not shown), to the voltage comparing unit 10. The voltage formed by subtracting the variable voltage applied to the variable resistor Rv from the input voltage Vcc is the above feedback voltage Vf.

It is desirable that the input voltage Vcc is maintained to be a constant voltage. However, when the input voltage Vcc is changed, the feedback voltage Vf, which is formed by subtracting the variable voltage from the input voltage Vcc, is chaged. That is, since the feedback voltage Vf is changed, the current supplied to the light source 20 through the voltage comparing unit 10 is changed. Therefore, the strength of the laser beam radiated from the laser diode of the light source 20 is changed according to the change of the current input into the light source 20, thus degrading the image quality output from the electric device.

### SUMMARY OF THE INVENTION

The present invention provides a light output controlling apparatus for preventing a change in the strength of a light by maintaining a feedback voltage applied to a voltage comparing unit constant.

According to an aspect of the present invention, there is provided a light output controlling apparatus, which includes a voltage comparing unit for comparing a reference voltage to a feedback voltage and a light source for radiating a light, including an input voltage supplying unit, which is connected to the light source, supplying the feedback voltage maintained constantly for the variable input voltage to the voltage comparing unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram of a conventional light output controlling apparatus; and

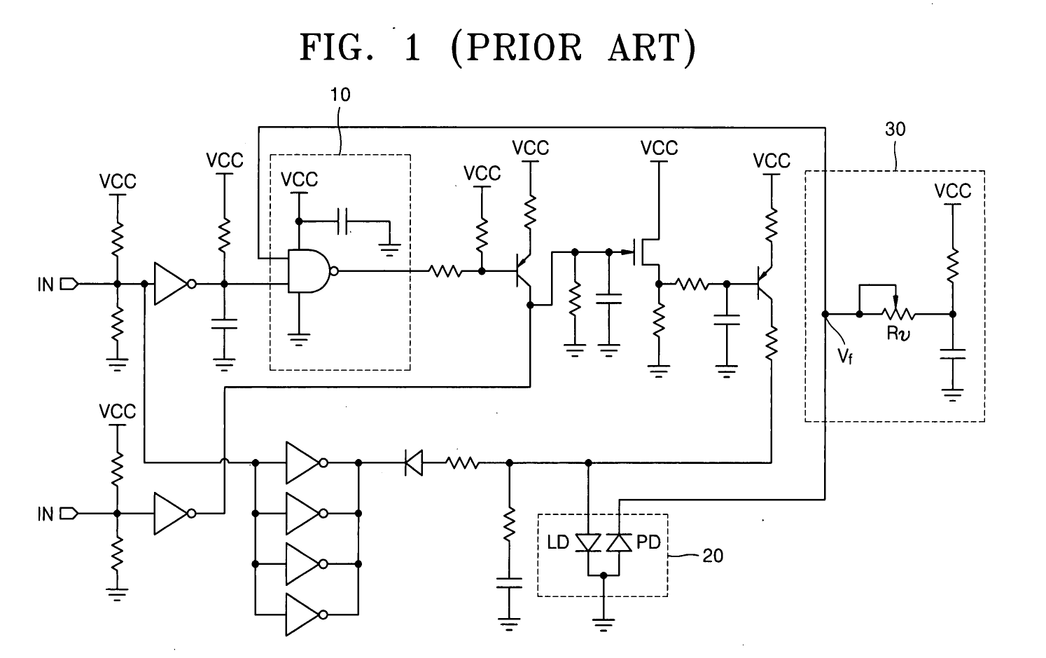

FIG. 2 is a circuit diagram of an apparatus for controlling output of light according to an embodiment of the present invention.

Throughout the drawings, it should be appreciated that the same reference numerals are used to depict the same or similar features and structures.

### DETAILED DESCRIPTION OF THE INVENTION

Hereinafter, a light output controlling apparatus according to an embodiment of the present invention will be described with reference to accompanying figure as follows.

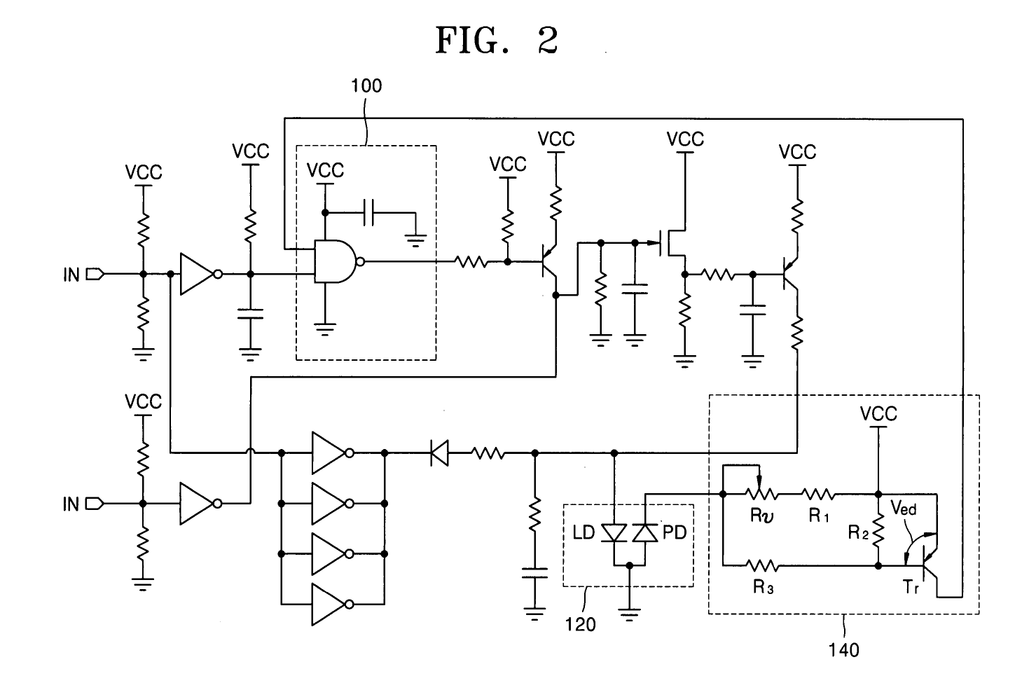

FIG. 2 is a circuit diagram of the apparatus for controlling the light output according to an embodiment of the present invention, and the apparatus includes a voltage comparing unit 100, a light source 120, and an input voltage supplying unit 140.

Functions of the voltage comparing unit 100 and the light source 120 are essentially the same as those of the conventional art, and descriptions for the functions will be omitted.

The input voltage supplying unit 140 is connected to the light source 120, and supplies a feedback voltage, which is maintained at a constant voltage for variable input voltages, to the voltage comparing unit 100. The input voltage supplying unit 140 includes a transistor Tr for maintaining the feedback voltage at a constant voltage. As shown in FIG. 2, an emitter of the transistor Tr is connected to an input voltage source (not shown), which supplies the input voltage Vcc, a base of the transistor Tr is connected to a variable resistor Rv, and a collector of the transistor Tr is connected to an input terminal of the voltage comparing unit 100.

The input voltage supplying unit 140 supplies a predetermined voltage between the emitter and the base of the transistor Tr as the feedback voltage of the voltage comparing unit 100. The predetermined voltage between the emitter and the base maintains a constant level even when the input voltage Vcc is changed. On the other hand, the input voltage Vcc is used as a switching voltage of the transistor Tr.

The input voltage supplying unit 140 further includes a resistor R1 for preventing an overcurrent from being generated due to a malfunction of the variable resistor Rv. The overcurrent preventing resistor R1 is preferably serially connected to the variable resistor Rv. Without resistor R1, the light source 120 may receive an overcurrent when the variable resistor is adjusted close to zero. Therefore, the overcurrent preventing resistor R1 prevents the overcurrent from being generated due to a malfunction or mis-operation of the variable resistor Rv.

The input voltage supplying unit 140 further includes a light strength controlling resistor R2 for controlling the strength of the light. The light strength controlling resistor R2 is connected in parallel to the variable resistor Rv. The light strength controlling resistor R2 controls the current supplied to the light source 120 to control the strength of the light radiated from the light source 120.

The input voltage supplying unit 140 further includes a voltage controlling resistor R3 for finely controlling the voltage when the transistor Tr is turned on. The voltage controlling resistor R3 is serially connected between the variable resistor Rv and the base of the transistor Tr. The voltage controlling resistor controls the voltage in the transistor Tr which the transistor is turned-on. The transistor Tr is switched by the input voltage Vcc.

As described above, the apparatus for controlling laser output maintains a constant feedback voltage, which is input into the voltage comparing unit, to prevent the strength of the light from changing, thus preventing the output image from degrading.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light output controlling apparatus including a voltage comparing unit for comparing a reference voltage to a feedback voltage and a light source for radiating a light, the apparatus comprising:
an input voltage supplying unit, which is connected to the light source and supplies the feedback voltage maintained at a constant voltage with respect to the variable input voltage to the voltage comparing unit.

2. The apparatus of claim 1, wherein the input voltage supplying unit comprises a transistor in order to maintain the feedback voltage at a constant voltage.

3. The apparatus of claim 2, wherein the transistor of the input voltage supplying unit includes an emitter, which is connected to an input voltage source, a base, which is connected to a variable resistor, and a collector, which is connected to an input terminal of the voltage comparing unit.

4. The apparatus of claim 3, wherein the input voltage supplying unit supplies a predetermined voltage flowing between the emitter and base of the transistor, as the feedback voltage to the voltage comparing unit.

5. The apparatus of claim 2, wherein the input voltage supplying unit further comprises an overcurrent preventing resistor for preventing overcurrent from being generated due to a mis-operation of the variable resistor.

6. The apparatus of claim 2, wherein the input voltage supplying unit further comprises a light strength controlling resistor for micro controlling the strength of the laser beam radiated from the light source.

7. The apparatus of claim 2, wherein the input voltage supplying unit further comprises a voltage controlling resistor for micro controlling the on-state voltage of the transistor.

8. A method of controlling light output comprising the steps of:
maintaining a feedback voltage at a constant voltage offset from an input voltage, and comparing the feedback voltage to a reference voltage, and supplying a current to a light source based on the comparison.

9. The method of claim 8, wherein the step of maintaining a feedback voltage at a constant voltage offset from the input voltage is accomplished with a transistor.

10. The method of claim 9, wherein a voltage between a collector of the transistor and a base of the transistor generates the offset from the input voltage.
